(19) United States
(12) Patent Application Publication
(10) Pub. No.: US 2009/0169290 A1
(43) Pub. Date: Jul. 2, 2009

(54) Vacuum Food Processor Canister Closure Valve

(75) Inventors: Fred B. Johnson, JR., Mukilteo, WA (US); Phillip Naegle, Smithfield, UT (US)

Correspondence Address: FISH & RICHARDSON P.C., P.O BOX 1022, Minneapolis, MN, 55440-1022, US

(73) Assignee: Marinade Master, LLC, Seattle, WA (US)

(21) Appl. No.: 12/333,669

(22) Filed: Dec. 12, 2008

Related U.S. Application Data
(60) Provisional application No. 61/013,064, filed on Dec. 12, 2007.

(51) Int. Cl. F16D 1/108

(52) U.S. Cl. 403/36

(57) ABSTRACT

A vacuum food processor canister vacuum coupling assembly includes a canister closure defining a recess in a top portion of the closure. A valve stud within the recess defines an upper rim and a vacuum port extending through the closure. A vacuum valve plunger includes a valve stem extending through the vacuum port and defines a pliable upper peripheral flange to engage the rim of the valve stud to form a releasable seal. A vacuum coupler fitting is constructed to be manually press-fitted onto the valve stud to provide a press-fit seal therebetween to enable evacuation of air from a canister through the vacuum port. The press-fit seal can be maintained without manual support. The valve plunger can be displaced to release the vacuum. The valve plunger is positioned within the recess and the vacuum coupler fitting has sufficient clearance to avoid displacing the valve plunger during fitting removal.

### CROSS-REFERENCE TO RELATED APPLICATIONS

This application claims priority to U.S. Provisional Patent Application Ser. No. 61/013,064, filed Dec. 12, 2007. The entire contents of the priority application are hereby incorporated by reference in its entirety.

### BACKGROUND

The invention relates generally to vacuum food processors and methods and more particularly to vacuum couplings for use with closures and canisters of food marinators.

Rotary tumblers are frequently used in combination with tumbling, to accelerate the “take-up” or penetration of marinades into meat fibers and to mix, clean, toss, bread and marinate various food products. Such vacuum tumbling devices typically include a cylindrical tumbling canister carrying multiple internal fins for tumbling, kneading or otherwise agitating the canister contents. Vacuum canisters are also used to preserve or extend the life of food products stored in the canister.

A vacuum is drawn in the canister prior to tumbling using a powered vacuum system connected to the canister or canister closure. Some known vacuum canister closures include manually operated valves, such as ball valves or the like, that require a sequence of manual operations in combination with operation of the vacuum system. Other known vacuum canister closures and vacuum systems require an operator to manually maintain pressure between the canister closure and a vacuum fitting on the vacuum system until sufficient pressure differential is created by the vacuum system to maintain a seal. Insufficient manual pressure in such systems makes it difficult to establish or maintain a seal sufficient to draw a vacuum in the canister. Still other known systems require manual operation of the vacuum pump.

Accordingly, improvements are sought in sealing a vacuum pump with a vacuum canister.

### SUMMARY

One aspect of the invention features a vacuum pump attached to a canister closure by a cup-shaped vacuum fitting press-fitted with a gasket over a valve stud on the canister closure to provide a seal. The connection between the closure and vacuum system is maintained without the need for continued manual pressure prior to or during operation of the vacuum system.

In one implementation, the valve stud defines a vacuum port that retains a pliable rubber plunger valve with a pliable upper peripheral flange that cooperates with a rim on the valve stud to provide a seal. Using a vacuum system, air is drawn from the canister through a gap between the plunger and valve stud. Upon removal of the vacuum system fitting from the valve stud, the plunger flange is pulled by the pressure differential against the rim on the valve stud to form a seal. Thus, the valve allows air to be pumped from the canister and provides an air-tight seal upon removal of the vacuum connection.

In one application, the lid is retained on the canister during tumbling by the differential between the canister interior pressure and atmospheric exterior pressure. To release the vacuum drawn in the canister, the user simply lifts or tilts the head of the plunger to again create a gap between the plunger flange and the valve stud rim to allow air to flow back through the vacuum port into the canister.

In another application, the vacuum system is disconnected from the canister closure prior to tumbling the canister. During tumbling, the canister is driven about its longitudinal axis by a friction drive wheel that engages textured bands or recesses on the canister exterior.

In some embodiments, the canister includes internal fins for agitating food products. The fins may be angled, curved, and otherwise configured to roll, knead or agitate food products in any desired manner.

Another aspect of the invention features a vacuum food processor canister vacuum coupling assembly including a canister closure defining a recess in a top portion of the closure. A valve stud is positioned within the recess in the closure and defines a vacuum port extending through the closure and an upper rim. A vacuum valve plunger including a valve stem extends through the vacuum port and defines a pliable upper peripheral flange about an upper portion of the valve stem configured to engage the rim of the valve stud to form a releasable seal. A vacuum coupler fitting is constructed to be manually press-fitted onto the valve stud to provide a press-fit seal therebetween to enable evacuation of air from a canister through the vacuum port.

In some implementations, the vacuum coupling assembly further includes a pliable gasket disposed between the vacuum coupler fitting and the valve stud to provide a press-fit.

In some implementations, the valve plunger includes a lower peripheral flange about a lower portion of the valve stem below the vacuum port.

In some implementations, the vacuum port defines a central axial bore extending through the valve stud and closure and further defines a passage extending radially from a lower portion of the central axial bore to allow air to pass between the lower peripheral flange and a lower portion of the closure adjacent the valve stem.

In some cases the valve stud is of a substantially uniform diameter. In other cases, the valve stud is tapered to provide a graduated press-fit. Still in other cases there are multiple projections on the valve stud for sealingly engaging the vacuum coupler fitting.

In a particular configuration, the valve plunger, the outer diameter of the valve stud and inner dimensions of the vacuum coupler fitting are configured to provide at least about 0.2 inches clearance between the valve plunger and vacuum coupler fitting.

Another aspect of the invention features a vacuum food tumbler including the vacuum coupling assembly as described; a vacuum canister configured to receive the closure; a base defining a cradle for receiving the canister; and a drive assembly within the base and comprising a drive motor and controller for rotating the canister in the cradle about a longitudinal axis of the canister.

One configuration includes a storage compartment accessible on a front portion of the base from which a vacuum line is extendible for use with the vacuum coupler fitting without the need to disconnect or connect the vacuum line relative to the base between uses.

In some embodiments, the canister includes multiple fins extending radially inward from an interior surface of the canister.

In some embodiments, the canister defines a textured circumferential groove on an exterior surface of the canister configured to engage the drive assembly of the base.

In some embodiments, the valve plunger is disposed entirely below an upper rim of the recess in the top portion of the closure.

In some embodiments, the press-fit seal is maintained without manual support or applied vacuum.

Another aspect of the invention features a method of evacuating a vacuum canister including positioning a closure on the vacuum canister. The closure defines a recess and a valve stud positioned within the recess in the closure. The valve stud defines a vacuum port extending to a bottom portion of the closure and further defines an upper rim. The closure further includes a vacuum valve plunger defining a valve stem extending through the vacuum port and defining a pliable peripheral flange about an upper portion of the valve stem. The valve plunger is configured to engage the rim of the valve stud to form a releasable seal. The method includes manually press-fitting a vacuum coupler fitting onto the valve stud to form a press-fit seal therebetween and evacuating air from the canister through the vacuum port and vacuum coupler fitting.

In some applications, the method includes overcoming the press-fit seal to remove the vacuum coupler fitting from the valve stud to allow a pressure differential between the interior and exterior of the canister to cause the valve plunger to be drawn against the rim of the valve stud to form a seal.

Other applications include securing the closure to the canister solely by the pressure differential.

Still other applications include displacing the peripheral flange of the valve plunger from the rim of the valve stud to return the canister to ambient pressure.

In some applications, the press-fit seal is maintained without manual support or applied vacuum

In some applications, the method includes displacing the peripheral flange of the valve plunger from the rim of the valve stud to return the canister to ambient pressure.

In some applications, the press-fit seal is sufficiently secure to retain the vacuum coupler fitting on the valve stud through multiple vacuum cycles without manual support.

In some applications, press-fitting the vacuum coupler fitting onto the valve stud includes compressing a pliable gasket.

The details of one or more implementations of features of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a vacuum tumbler base and canister with a vacuum system connected to a canister closure.

FIG. 2 is a perspective view of a vacuum tumbler with a vacuum canister and closure assembly driven on the tumbler base.

FIG. 3 is a side view showing a vacuum canister and closure assembly on a vacuum tumbler base.

FIG. 4 is a cross-sectional view of the vacuum tumbler base of FIG. 3.

FIG. 5 is an exploded view of the vacuum canister and closure assembly of FIG. 3.

FIG. 6 is a perspective view of a vacuum canister closure.

FIGS. 7a-c are top, side and bottom views of the canister closure of FIG. 6.

FIG. 8a-b are cross-sectional views of the canister closure of FIG. 7a.

FIG. 9 is a perspective view of a vacuum valve plunger.

FIGS. 10a-c show top, side and cross-sectional views of the vacuum valve plunger of FIG. 9.

FIG. 11 is a perspective view of a vacuum fitting assembly for use with a vacuum valve.

FIG. 12 is a perspective view of a vacuum fitting cup for use in the vacuum fitting assembly of FIG. 11.

FIGS. 13a-c are front, side and bottom views of the vacuum fitting cup of FIG. 12.

FIGS. 14a-d are cross-sectional and detail views of the vacuum fitting cup of FIGS. 13a-c.

FIG. 15 is a perspective view of a vacuum fitting coupler.

FIGS. 16a-c are side, bottom and cross-sectional views of the vacuum fitting coupler of FIG. 15.

FIG. 17 is a perspective view of the vacuum canister of FIG. 3.

FIGS. 18a-c show side, top and partial cross-sectional views of the vacuum canister of FIG. 17.

FIGS. 19a-c show cross-sectional and detailed views of the vacuum canister of FIGS. 18a-c.

FIG. 20 is a side view of the vacuum canister of FIG. 17 showing textured drive recess on the canister exterior.

### DETAILED DESCRIPTION

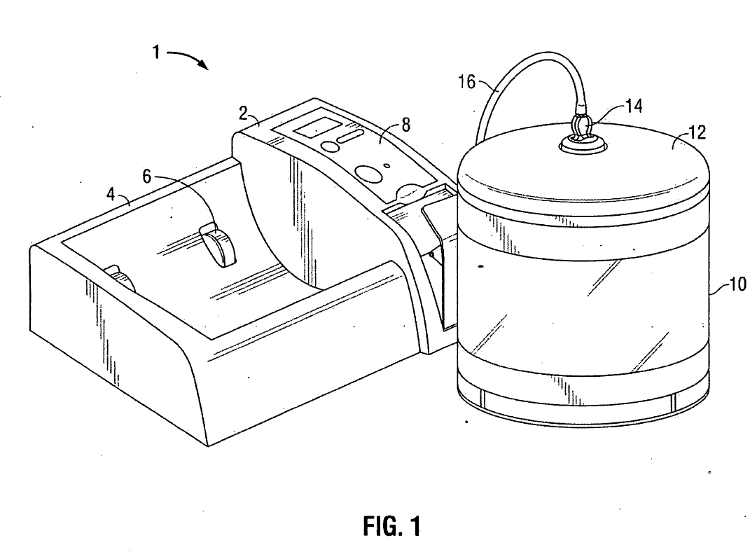

While aspects and features of the invention are applicable in many food processing and other vacuum and/or tumbling applications, implementations are described in the context of a vacuum tumbler for marinating meats and other food products. With reference to FIG. 1, a vacuum food tumbler 1 is shown including a base 2 defining a cradle 4 and housing a drive assembly 6. Drive assembly 6 is controlled by a controller 8 attached to base 4. Tumbler 1 includes a canister 10 and closure 12. A vacuum coupler assembly 14 is attached to closure 12 to evacuate air from canister 10 through a vacuum line 16.

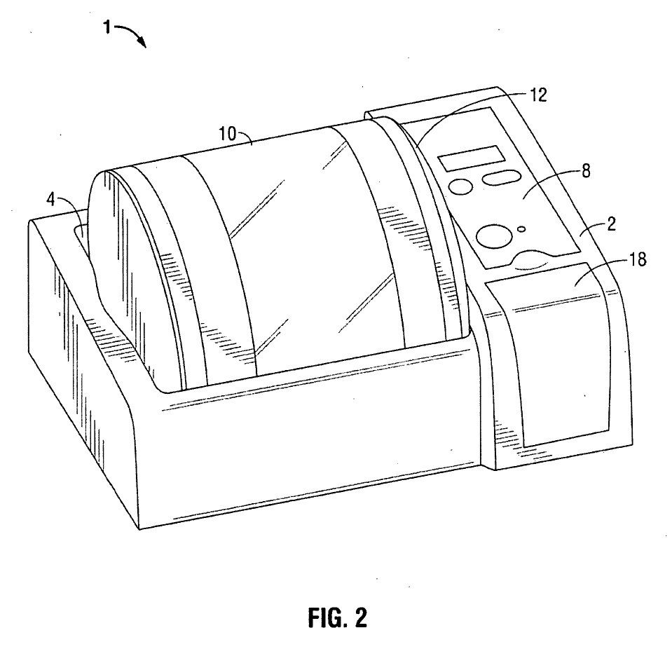

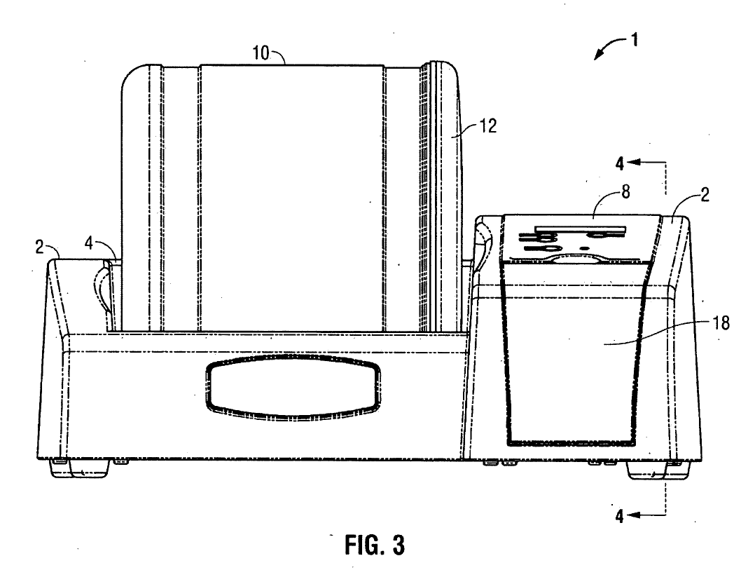

With reference to FIGS. 2-3, vacuum food tumbler 1 is shown with canister 10 positioned in cradle 4 of base 2. A storage compartment 18 stores vacuum line 16 and vacuum coupler assembly 14. As described below, vacuum line 16 is connected to a vacuum pump (not shown) within base 2 and remain connected to the pump between uses and storage.

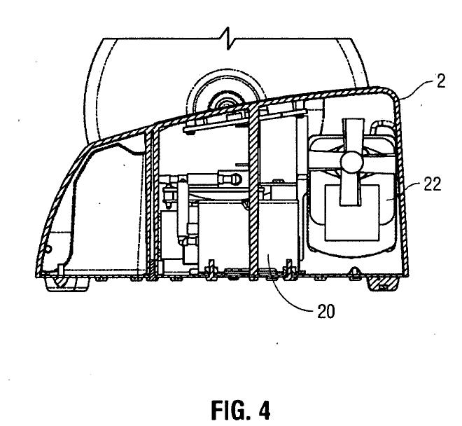

With reference to FIG. 4, base 2 houses a vacuum pump 20 and drive motor 22. Both vacuum pump 20 and drive motor 22 are controlled by controller 8. Vacuum pump 20 is automatically shut off upon detection of a predetermined vacuum level.

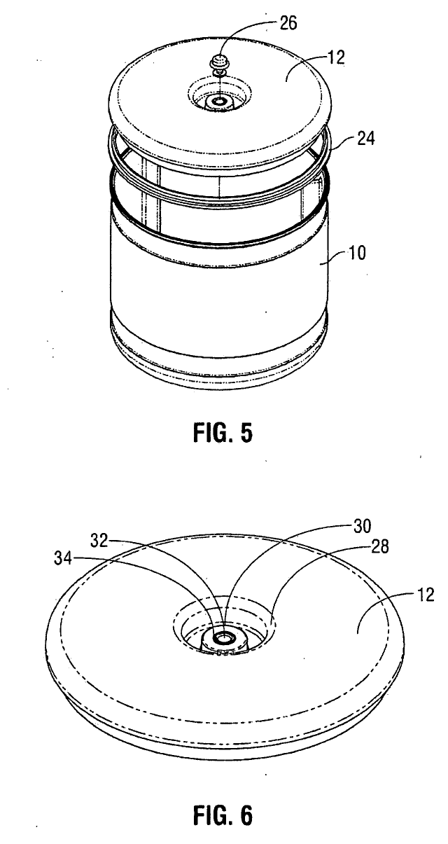

With reference to FIG. 5, a closure seal 24 is retained on closure 12 and is compressed between canister 10 and closure 12 when a vacuum is applied to canister 10. A valve plunger 26 is moveably seated in closure 12 as described below in more detail.

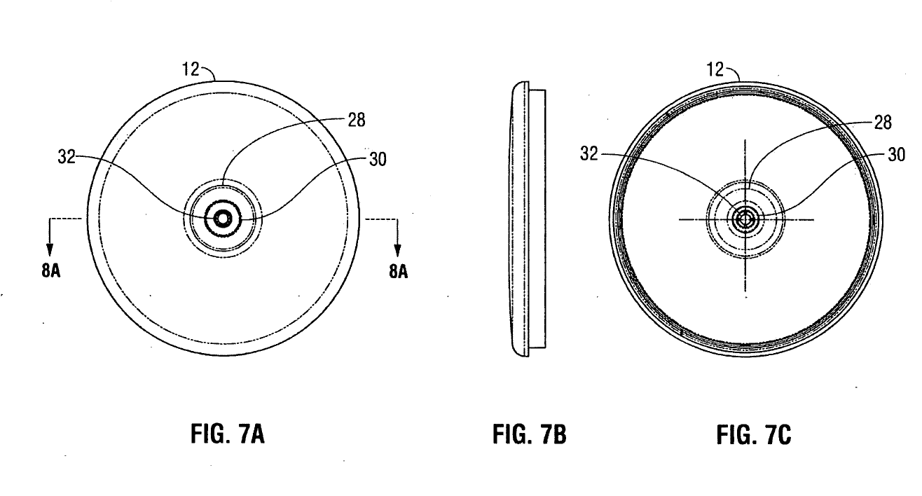

Referring to FIGS. 6-8, closure 12 defines a recess 28 on a top portion of closure 12. Closure 12 further includes a valve stud 30 positioned within the recess and extending upwardly therefrom. Valve stud 30 defines a vacuum port 32 extending from the top of valve stud 30 to a lower portion of closure 12. Valve stud 30 further defines a rim 34 on an upper surface for sealingly engaging valve plunger 26.

Valve stud 30 is sized and configured to receive a compact vacuum fitting assembly 14 thereon while providing sufficient clearance between the vacuum fitting assembly 14 and valve plunger 26 to prevent inadvertent disruption of the seal between plunger 26 and valve stud 30. In some implementations, valve stud 30 is of a uniform diameter, while in other implementation, valve stud 30 is tapered to provide a graduated press-fit with vacuum fitting assembly 14. Still in other implementations, valve stud 30 includes a recess or projection to provide a snap-fit with a complementary feature on vacuum fitting assembly 14. For example, an O-ring on one may be received into a recess in the other. In other implementations, valve stud 30 includes multiple projections such as rim 34 for engaging vacuum fitting assembly 14 to provide enhanced sealing.

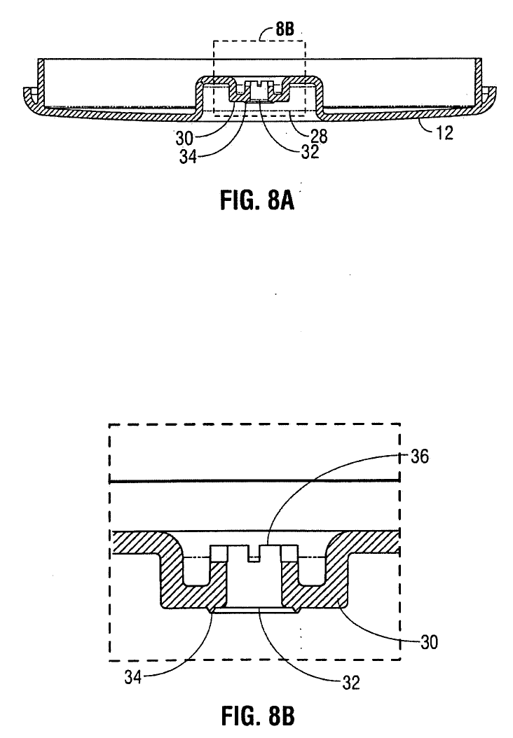

Referring to FIG. 8-b, valve stud 30 defines vacuum port 32 axially therethrough and valve plunger 26 rests against a lower surface of closure 12 adjacent vacuum port 32. A vacuum passage 36 extends radially from vacuum port 32 on a lower portion of closure 12. Accordingly, air passage 36 provides air flow between valve plunger 26 and the lower portion of closure 12. Air passage 36 also serves to prevent food stuffs from being, aspirated into vacuum line 16 through vacuum port 32. Multiple air passages 36 may be positioned about vacuum port 32 to provide increased air flow. A shroud can be employed about air passages 36 or vacuum port 32 to further ensure that only air is allowed to enter vacuum line 16.

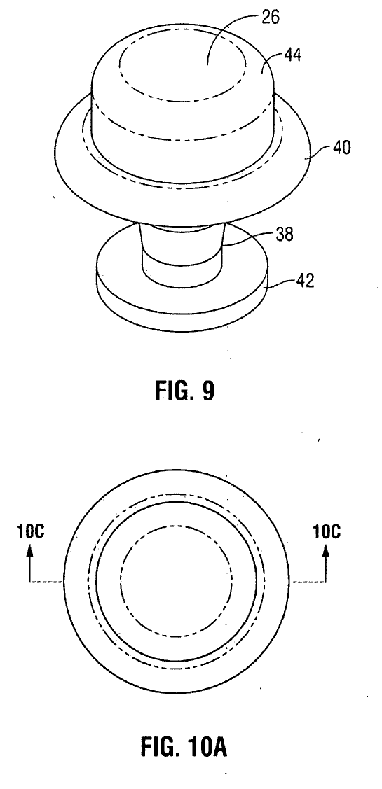

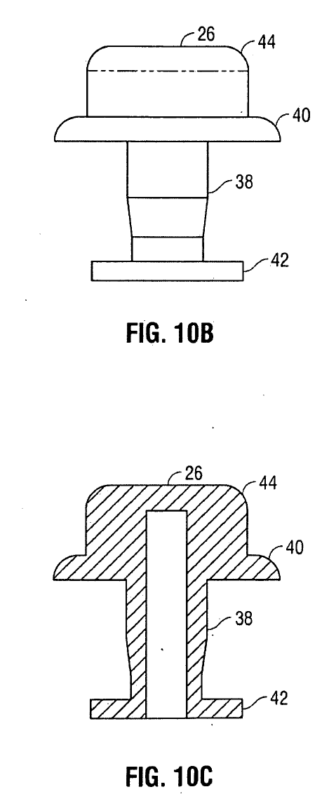

Referring to FIGS. 9-10c, valve plunger 26 defines a valve stem 38, an upper peripheral flange 40 about an upper portion of valve stem 38 and a lower peripheral flange 42 about a lower portion of valve stem 38. Lower peripheral flange 42 serves to retain valve plunger in vacuum port 32. Upper peripheral flange 40 is pliable and engages upper rim 34 of valve stud 30 to form a seal when a vacuum is applied to canister 10. A projection 44 is provided at the top of valve stem 38 and allows a user to displace upper peripheral flange 40 from rim 34 to return canister 10 to ambient pressure. Valve plunger 26 is formed of a medium durometer rubber or elastomeric material to suitably seal with valve stud 30.

Thus, valve plunger 26 allows air to be evacuated from canister 10 but does not allow air to return back to canister 10 unless the seal is compromised by manually deforming or displacing valve plunger 26. Once the vacuum is released, closure 12 may again be removed from canister 10. It is advantageous that valve plunger 26 be located entirely within recess 28 on closure 12 to prevent inadvertent loss of the vacuum applied to canister 10, for example, by an impact with base 2 during operation.

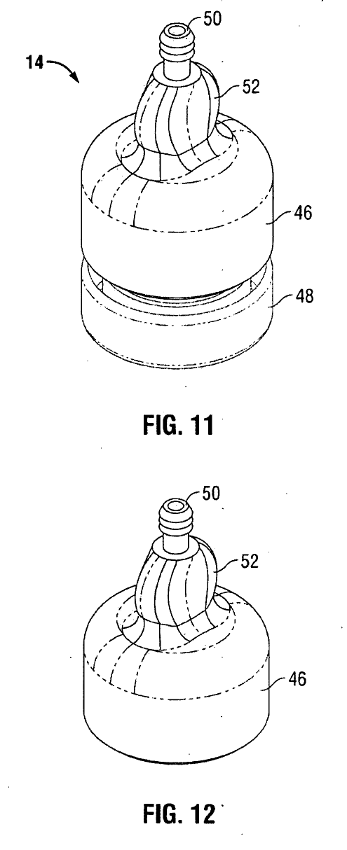

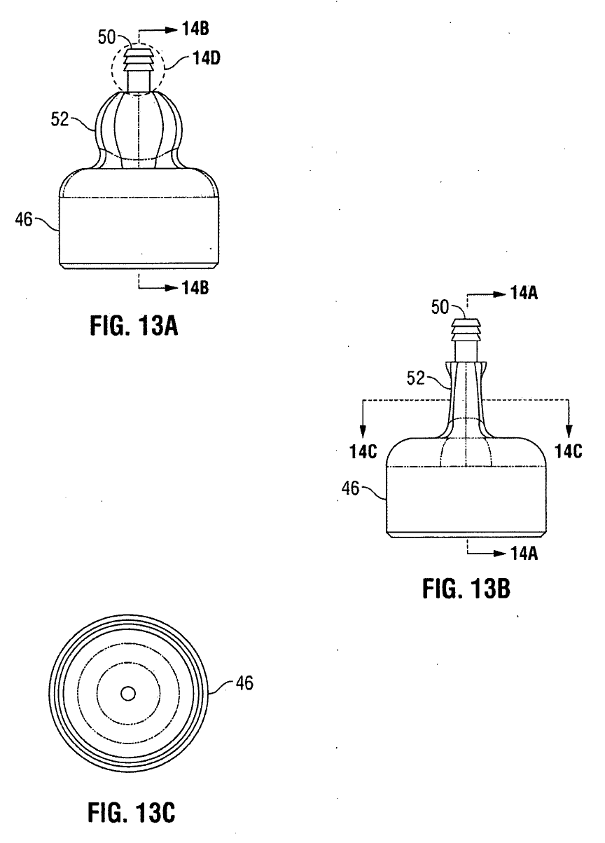

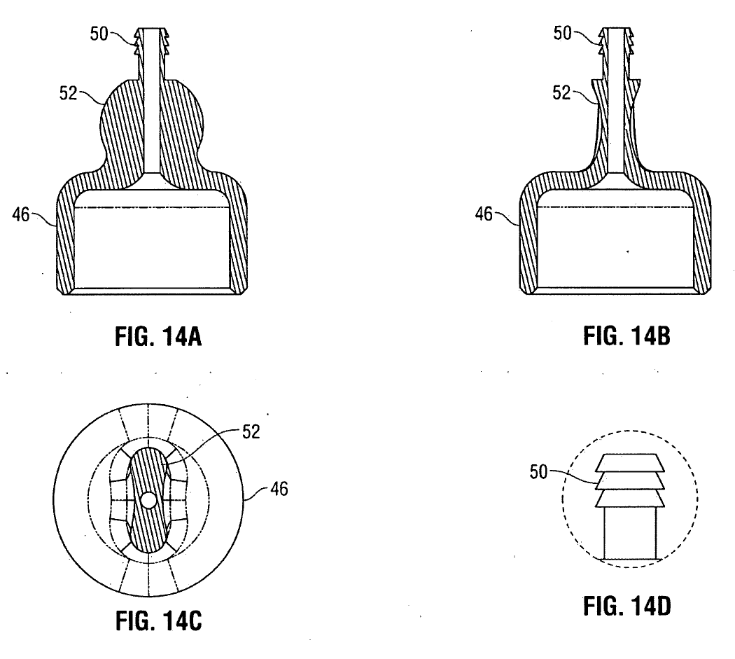

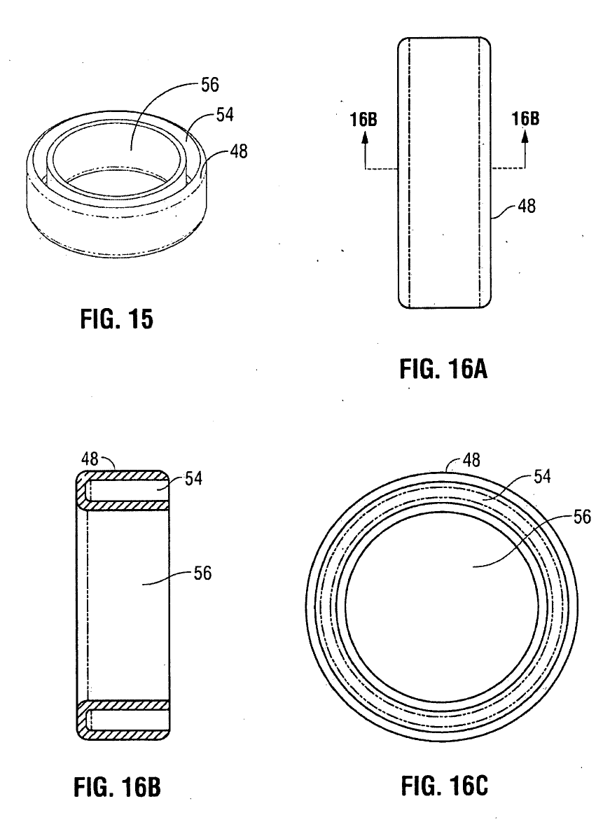

With reference to FIGS. 11-16, a vacuum coupler assembly 14 includes a vacuum cup 46 and a vacuum coupler fitting 48. While vacuum cup 46 and vacuum coupler fitting 48 are shown as separate components, other configurations provide for an integral vacuum coupler assembly 14. Vacuum cup 46 includes a barbed fitting 50 on an upper portion of a handle portion 52 for connection to vacuum line 16.

Vacuum coupler fitting 48 is sized and configured to be received within recess 28 on closure 12 over valve stud 30 within recess 28. In a particular embodiment, vacuum cup 46 is sized and configured with sufficient clearance to prevent displacement of valve plunger 26 or compromise of the seal between valve plunger 26 and valve stud 30 upon removal of valve coupler assembly 14.

Vacuum coupler 48 defines an annular recess 54 configured to sealingly receive vacuum cup 46. Vacuum coupler 48 further defines a central socket 56 sized to provide an interference press-fit with valve stud 30 upon manual connection by a user. Vacuum coupler 48 may be provided in various cases with a gasket around the circumference of socket 56 to provide the press-fit seal with valve stud 30.

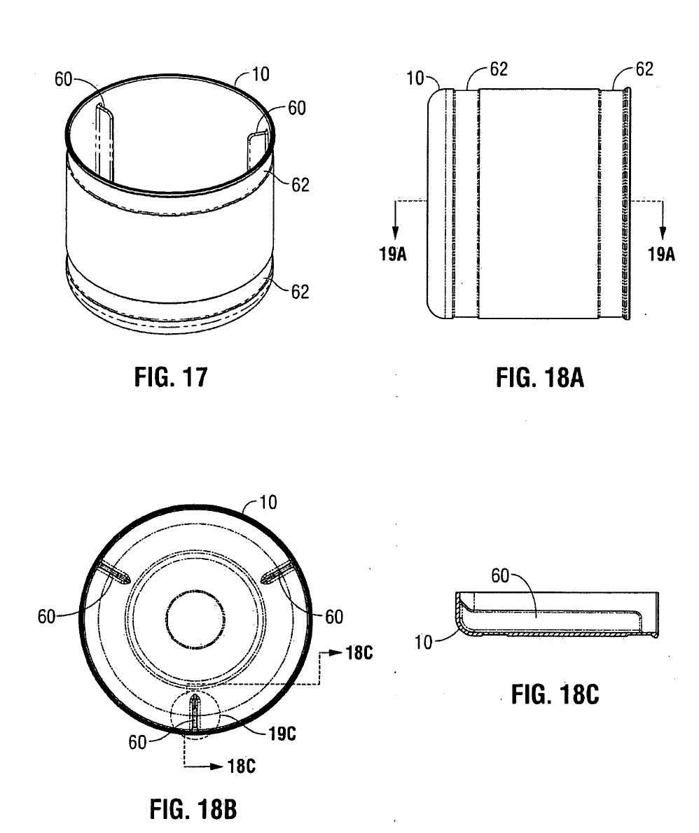

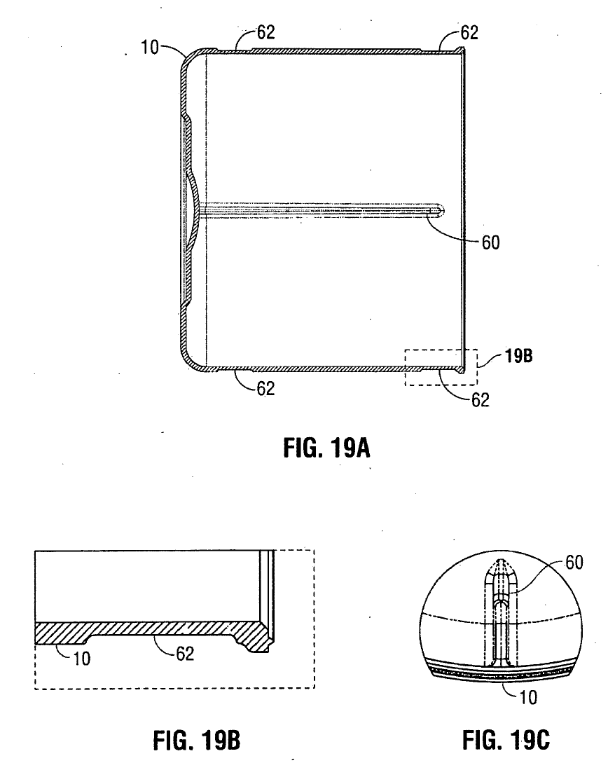

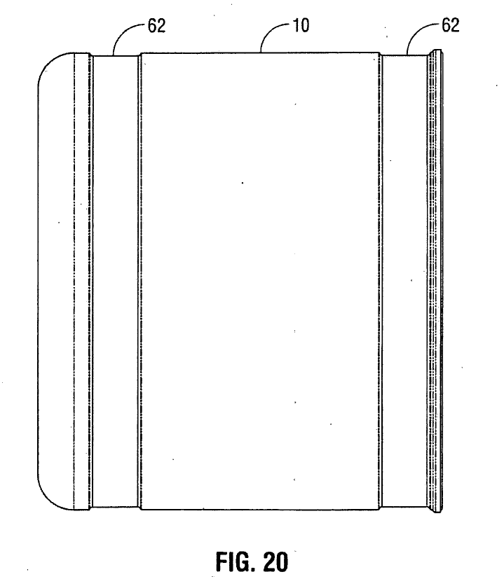

With reference now to FIGS. 17-20, canister 10 is shown in one example to include internal fins 60 extending radially inward from an interior surface of canister 10. It has been found that three fins of approximately 0.75 inch in height provide sufficient kneading or bending of most meat products without causing undue damage to the meat.

Canister 10 defines textured recesses 62 that extend circumferentially about the exterior of canister 10. Texturing of recesses 62 provides increased friction between canister 10 and drive assembly 6. This is particularly advantageous when the canister is wet or greasy from pouring of food products or handling. The texturing may be provided by texturing the mold or by after-mold processes such as sandblasting or chemical etching.

Canister 10 includes reinforcing structure on the bottom thereof to stiffen canister 10. The reinforcing structure can include steps, ribs or other structure to provide strength. Convex bottom surface provides strength, stiffness and a more uniform surface that is easier to clean. The internal tumbling fins go further serve to reinforce the side wall of canister 10. The three fins also tie into the bottom of the canister to provide strength as ribs.

According to one application, a method of evacuating a vacuum canister includes positioning closure 12 on vacuum canister 10. The closure 12 defines a recess 28 and a valve stud 30 is positioned within recess 28 in closure 12. Valve stud 30 defines a vacuum port 32 extending to a bottom portion of closure 12 and an upper rim 34. Valve plunger 26 includes a valve stem 38 extending through vacuum port 32 and defines a pliable upper peripheral flange 40 about an upper portion of valve stem 38 to engage rim 34 of valve stud 30 to form a releasable seal. The method further includes press-fitting vacuum coupler fitting 14 onto valve stud 30 to form a seal therebetween and evacuating air from canister 10 through vacuum port 32 and vacuum coupler fitting 14. By removing vacuum coupler fitting 14 from valve stud 30, the pressure differential between the interior and exterior of canister 10 causes valve plunger 26 to be drawn against rim 34 of valve stud 30 to form a seal. Closure 12 can be secured to canister 10 solely by the pressure differential. Displacing upper peripheral flange 40 from rim 34 of valve stud 30 allows canister 10 to return to ambient pressure.

A number of implementations and applications of the invention have been described. Nevertheless, it will be understood that various modifications may be made without departing from the spirit and scope of the invention. For example, various components of canister 10, closure 12 or vacuum coupler assembly 14 may be formed integrally or may be separate components that are connected together. Accordingly, other configurations are within the scope of the following claims.

What is claimed is:

1. A vacuum food processor canister vacuum coupling assembly comprising:
a canister closure defining a recess in a top portion of the closure;
a valve stud positioned within the recess in the closure and defining a vacuum port extending through the closure, the valve stud further defining an upper rim;
a vacuum valve plunger including a valve stem extending through the vacuum port and defining a pliable upper peripheral flange about an upper portion of the valve stem configured to engage the rim of the valve stud to form a releasable seal; and
a vacuum coupler fitting sized and configured to be manually press-fitted onto the valve stud to provide a press-fit seal therebetween to enable evacuation of air from a canister through the vacuum port.

2. The vacuum coupling assembly of claim 1, further comprising a pliable gasket disposed between the vacuum coupler fitting and the valve stud.

3. The vacuum coupling assembly of claim 1, further comprising a lower peripheral flange about a lower portion of the valve stem below the vacuum port.

4. The vacuum coupling assembly of claim 3, wherein the vacuum port defines a central axial bore extending through the valve stud and closure and further defines a passage extending radially from a lower portion of the central axial bore to allow air to pass between the lower peripheral flange and a lower portion of the closure adjacent the valve stem.

5. The vacuum coupling assembly of claim 1, further comprising a shroud adjacent the lower portion of the vacuum port to prevent aspiration of food products through the vacuum port during operation of a vacuum system.

6. The vacuum coupling assembly of claim 1, wherein the valve plunger is disposed entirely below an upper rim of the recess in the top portion of the closure.

7. The vacuum coupling assembly of claim 1, wherein the valve stud is tapered to provide a graduated press-fit.

8. The vacuum coupling assembly of claim 1, further comprising multiple projections on the valve stud for sealingly engaging the vacuum coupler fitting.

9. The vacuum coupling assembly of claim 1, wherein the valve plunger, an outer diameter of the valve stud and inner dimensions of the vacuum coupler fitting are configured to provide at least about 0.2 inches clearance between the valve plunger and vacuum coupler fitting.

10. A vacuum food tumbler comprising:
the vacuum coupling assembly of claim 1;
a vacuum canister configured to receive the closure;
a base defining a cradle for receiving the canister; and
a drive assembly within the base and comprising a drive motor and controller for rotating the canister in the cradle about a longitudinal axis of the canister.

11. The vacuum food tumbler of claim 10, further comprising a storage compartment accessible on a front portion of the base from which a vacuum line is extendible for use with the vacuum coupler fitting without the need to disconnect or connect the vacuum line relative to the base between uses.

12. The vacuum food tumbler of claim 10, wherein the canister includes multiple fins extending radially inward from an interior surface of the canister.

13. The vacuum food tumbler of claim 10, wherein the canister defines a textured circumferential groove on an exterior surface of the canister configured to engage the drive assembly of the base.

14. A method of evacuating a vacuum canister comprising:
positioning a closure on the vacuum canister, the closure defining a recess and a valve stud positioned within the recess in the closure, the valve stud defining a vacuum port extending to a bottom portion of the closure, the valve stud further defining an upper rim, the closure further including a vacuum valve plunger defining a valve stem extending through the vacuum port and defining a pliable peripheral flange about an upper portion of the valve stem and configured to engage the rim of the valve stud to form a releasable seal;
manually press-fitting a vacuum coupler fitting onto the valve stud to form a press-fit seal therebetween; and
evacuating air from the canister through the vacuum port and vacuum coupler fitting.

15. The method of claim 14, further comprising overcoming the press-fit seal to remove the vacuum coupler fitting from the valve stud to allow a pressure differential between the interior and exterior of the canister to cause the valve plunger to be drawn against the rim of the valve stud to form a seal.

16. The method of claim 15, further comprising securing the closure to the canister solely by the pressure differential.

17. The method of claim 15, further comprising displacing the peripheral flange of the valve plunger from the rim of the valve stud to return the canister to ambient pressure.

18. The method of claim 15, wherein the press-fit seal is sufficiently secure to retain the vacuum coupler fitting on the valve stud through multiple vacuum cycles without manual support.

19. The method of claim 15, wherein press-fitting the vacuum coupler fitting onto the valve stud includes compressing a pliable gasket.

20. The method of claim 15, wherein the press-fit seal includes a snap fit between complementary features of the vacuum coupler fitting and the valve stud.
